(19) United States
(12) Patent Application Publication
(10) Pub. No.: US 2024/0119425 A1
(43) Pub. Date: Apr. 11, 2024

(54) MANAGEMENT METHOD AND MANAGEMENT DEVICE FOR WASTE TREATMENT SERVICE AND COMPUTER-READABLE MEDIUM

(71) Applicant: TOYOTA JIDOSHA KABUSHIKI KAISHA, Toyota-shi (JP)

(72) Inventors: Yuki ICHIOKA, Kawasaki-shi (JP); Tomoyuki KAGA, Mishima-shi (JP); Hideo HASEGAWA, Nagoya-shi (JP); Hiroya MATSUBAYASHI, Tokyo-to (JP); Nobuhisa OTSUKI, Tokyo-to (JP)

(73) Assignee: TOYOTA JIDOSHA KABUSHIKI KAISHA, Toyota-shi (JP)

(21) Appl. No.: 18/232,582

(22) Filed: Aug. 10, 2023

(30) Foreign Application Priority Data
Oct. 7, 2022 (JP) 2022-162363

(51) Int. Cl. G06Q 10/30; G06Q 30/0202

(52) U.S. Cl. CPC G06Q 10/30; G06Q 30/0202

(57) ABSTRACT

At least one of a discharging tendency of waste based on a discharge history of discharge of the waste by a user of a service and a discharge prediction about the waste based on the purchase history of a product by the user is calculated. A need prediction about the service is calculated by using a prediction model which uses, as a parameter, at least one of the discharging tendency of the waste and the discharge prediction about the waste. A level of the service is estimated by a simulation which uses, as parameters, the need prediction and a resource employed for the service. A notification is transmitted to the user suggesting a modification of behavior of at least one of discharge of the waste and purchase of a product by the user based on a comparison result between an estimated level and a stipulated level of the service.

### CROSS-REFERENCE TO RELATED APPLICATION

The present disclosure claims priority under 35 U.S.C. § 119 to Japanese Patent Application No. 2022-162363, filed on Oct. 7, 2022, the content of which application is incorporated herein by reference in their entirety.

### FIELD

The present disclosure relates to a method and a device for managing a service related to treatment of waste (trash) and a computer-readable medium.

### BACKGROUND

JP 2021-182456 A discloses a method of managing collection, transportation, and disposal of waste. The method in related art accumulates information about kinds and amounts of waste discharged from discharging parties of waste. Based on the accumulated information, a discharged amount of waste at a specific day is predicted for each kind of waste. A collection-transportation operator of waste and a disposal operator of waste respectively make plans of collection and transportation and of disposal of waste based on predicted information.

JP 2021-179825 A discloses a management method of vehicles for collecting and transporting waste. The method in related art receives waste information (size, weight, quantity, and so forth) from each terminal of a user discharging waste. A total amount of waste desired to be collected in a predetermined district is calculated, and based on the total amount, vehicle allocation plans of collection-transportation vehicles to be dispatched into the predetermined district are made.

### SUMMARY

The above methods in related art predict a discharging manner of future waste from information about discharging actions of subjects of waste such as discharging parties of waste and users and make plans of collection, transportation, and so forth of waste in accordance with the discharging manner. Thus, an improvement in convenience of services related to a series of waste treatments from collection and transportation to disposal is expected, but it is difficult to cause the subjects of waste to have an intention of reducing discharged amounts of waste. Consequently, there is a possibility that when an amount of waste which exceeds a capacity of operators involved in waste treatment is predicted to be discharged, it becomes difficult to make appropriate plans, and on the contrary, convenience of the services is thus impaired.

One object of the present disclosure is to provide a technique which is capable of in advance preventing convenience of a service related to waste treatment from being impaired and of appropriately practicing the service.

A first aspect of the present disclosure is a method to manage a service related to waste treatment, and has the following features.

The method comprising the steps of:
obtaining at least one of a discharge history of discharge of waste by a user using the service and a purchase history of a product by the user;
calculating at least one of a discharging tendency of discharge of the waste by the user based on the discharge history and a discharge prediction about discharge of the waste by the user based on the purchase history;
calculating a need prediction about the service by using a prediction model which uses, as a parameter, at least one of the discharging tendency of the waste and the discharge prediction about the waste;
estimating a level of the service by a simulation which uses, as parameters, the need prediction and a resource employed for the service; and
transmitting, to a terminal of the user, a notification which suggests a modification of behavior of at least one of discharge of the waste and purchase of a product by the user based on a comparison result between an estimated level and a stipulated level of the service.

A second aspect of the present disclosure is a device to manage a service related to waste treatment, and has the following features.

The device comprises a memory and a processor. The memory stores at least one of a discharge history of discharge of waste by a user using the service and a purchase history of a product by the user. The processor is configured to execute processing based on data stored in the memory.

The processor is configured to:
calculate at least one of a discharging tendency of discharge of the waste by the user based on the discharge history of the waste and a discharge prediction about discharge of the waste by the user based on the purchase history;
calculate a need prediction about the service by using a prediction model which uses, as a parameter, at least one of the discharging tendency of the waste and the discharge prediction about the waste;
estimate a level of the service by a simulation which uses, as parameters, the need prediction and a resource employed for the service; and
transmit, to a terminal of the user, a notification which suggests a modification of behavior of at least one of discharge of the waste and purchase of a product by the user based on a comparison result between an estimated level and a stipulated level of the service.

A third aspect of the present disclosure is a non-transitory computer-readable medium storing a program to manage a service related to waste treatment.

The program causing a computer to execute:
processing to obtain at least one of a discharge history of discharge of waste by a user using the service and a purchase history of a product by the user;
processing to calculate at least one of a discharging tendency of discharge of the waste by the user based on the discharge history and a discharge prediction about discharge of the waste by the user based on the purchase history;
processing to calculate a need prediction about the service by using a prediction model which uses, as a parameter, at least one of the discharging tendency of the waste and the discharge prediction about the waste;
processing to estimate a level of the service by a simulation which uses, as parameters, the need prediction and a resource employed for the service; and
processing to transmit to a terminal of the user a notification which suggests a modification of behavior of at least one of discharge of the waste and purchase of a product by the user based on a comparison result between an estimated level and a stipulated level of the service.

In the present disclosure, a simulation is performed which uses, as parameters, a need prediction about a need for a service related to waste treatment and a resource employed for the service, and a level of the service is thereby estimated. A notification is transmitted which suggests a modification of behavior of at least one of discharge of the waste and purchase of a product by the user in accordance with a comparison result between the above estimated level and a stipulated level. Consequently, it becomes possible to in advance prevent convenience of a service related to waste treatment from being impaired and to appropriately practice the service.

### BRIEF DESCRIPTION OF DRAWINGS

FIG. 1 is a diagram for explaining an outline of a service related to waste treatment;

FIG. 2 is a diagram for explaining configuration examples of a treatment facility and home;

FIG. 3 is a diagram for explaining a transition example of a service level;

FIG. 4 is a diagram for explaining a general configuration example of a waste treatment system including a management server;

FIG. 5 is a diagram for explaining a function configuration example of the management server;

FIG. 6 is a flowchart illustrating a flow of processing executed by a data processing device and particularly relates to the embodiment; and

FIG. 7 is a flowchart illustrating a flow of processing executed in step S15 in FIG. 6.

### DESCRIPTION OF EMBODIMENT

An embodiment of the present disclosure will hereinafter be described with reference to drawings. Note that the same reference characters are given to the same or corresponding components in the drawings, and descriptions thereof will be simplified or will not be repeated.

### 1. OUTLINE

### 1-1. Service Related to Waste Treatment

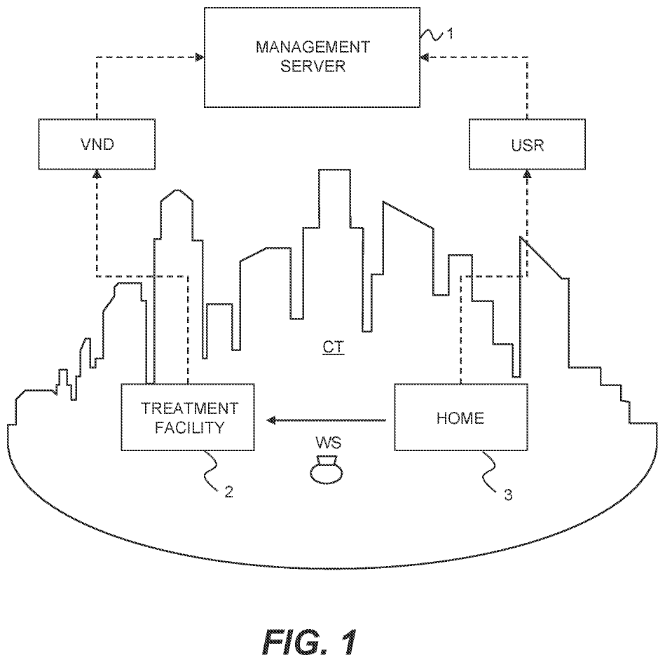

FIG. 1 is a diagram for explaining an outline of a service related to waste treatment (hereinafter, also referred to as “waste treatment service” or “treatment service”). In FIG. 1, a city CT is illustrated, and the treatment service is provided in the city CT. Here, the city CT means a physical space in which plural services including the treatment service are provided and life of plural individuals takes places. A scale of the city CT in the present disclosure is not limited. A so-called smart city is one example of a large scale city CT, an underground town is one example of an intermediate scale city CT, and a large-sized building is one example of a small scale city CT.

FIG. 1 illustrates a management server 1 which manages the treatment service, a treatment facility 2 of a vendor which provides the treatment service, and a home 3 of a user UX who uses the treatment service. The management server 1 corresponds to a management device according to the embodiment. In order to manage the treatment service, the management server 1 actively or passively collects data (hereinafter, also referred to as “vendor data”) VND related to the vendor which manages the treatment facility 2. The management server 1 actively or passively collects data (hereinafter, also referred to as “user data”) USR related to the user UX living in the home 3. Based on the vendor data VND and the user data USR, the management server 1 performs data processing (described later) for managing the waste treatment service.

The treatment facility 2 performs treatments (including intermediate disposal and final disposal) of waste WS discharged from the home 3. The total number of treatment facilities 2 is at least one. As the vendor which manages the treatment facility 2, a juridical person and a local government are raised as examples. Similarly to the total number of treatment facilities 2, the total number of homes 3 is at least one. As the user UX living in the home 3, a juridical person and a natural person are raised as examples. When the user UX is a juridical person, the home 3 is assumed to be a business site such as a store or a facility of the juridical person.

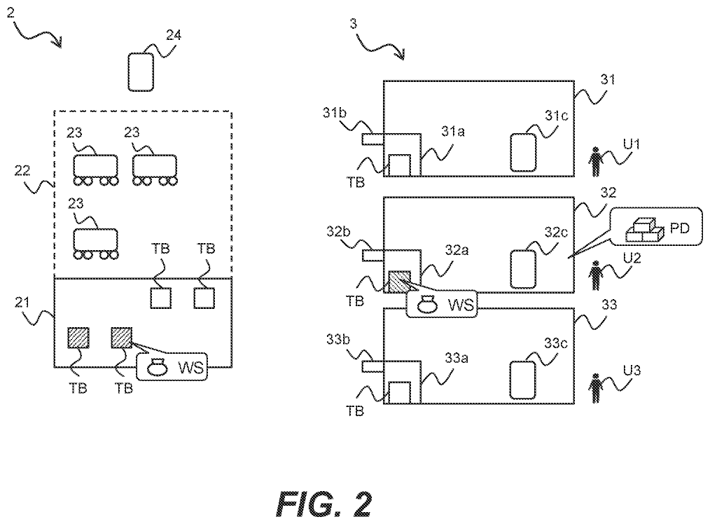

FIG. 2 is a diagram for explaining configuration examples of the treatment facility 2 and the home 3. In the example illustrated in FIG. 2, the treatment facility 2 includes a treatment space 21 and a waiting space 22. In the treatment space 21, unloading of a container TB containing the waste WS is performed from a moving body 23. In the treatment space 21, the waste WS is taken out from the container TB and is disposed of. In the treatment space 21, in addition, loading of the empty container TB is performed to the moving body 23. Plural moving bodies 23 are waiting in the waiting space 22. A terminal (hereinafter, also referred to as “vendor terminal”) 24 of the vendor which manages the treatment facility 2 communicates with each of those moving bodies 23 via a network.

Each of the moving bodies 23 retrieves and transports the container TB. Specifically, the moving body 23 retrieves the container TB containing the waste WS from the home 3 in accordance with an instruction (retrieval instruction) from the vendor terminal 24. The moving body 23 replenishes the home 3 with the empty container TB in accordance with an instruction (replenishment instruction) from the vendor terminal 24. An occupant (such as a driver or a worker, for example) may ride on or may not ride on each of the moving bodies 23. Each of the moving bodies 23 may have a function of autonomous driving and may have functions of automatic retrieval of and automatic replenishment with the container TB.

The vendor terminal 24 manages retrieval of and replenishment with the container TB by the moving body 23. Retrieval of and replenishment with the container TB are regularly performed and are performed in response to a demand (on demand) from the home 3. Thus, the vendor terminal 24 performs management of the containers TB and the moving bodies 23 for handling regular retrieval of and replenishment with the containers TB and retrieval of and replenishment with the containers TB on demand. In order to perform this management, data about an operating situation of the containers TB and the moving bodies 23 are perceived by the vendor terminal 24. As the data about the operating situation, positions of the containers TB and the moving bodies 23, states of the moving bodies 23 (such as moving, waiting, charging, under inspection, retrieving the container TB, and in replenishment with the container TB, for example), cruisable distances of the moving bodies 23, and so forth are raised as examples.

The vendor terminal 24 manages disposal of the waste WS which is performed at the treatment space 21. As well as the data about operating situation, data about a disposal situation of the waste WS at the treatment space 21 are perceived by the vendor terminal 24. The data about the disposal situation are recorded for each combination of a kind of the waste WS and the operating situation of equipment for disposing of the above kind of waste WS, for example. As kinds of the waste WS, combustible trash, non-combustible trash, and special trash (for example, recyclable trash, bottles, and cans) are raised as examples. As the equipment for disposing of the waste WS, equipment for performing temporary preservation, separation, and so forth of the waste WS, equipment for performing incineration, dismantling, and so forth of the waste WS, equipment for treating ash, exhaust gas, or waste water produced accompanying disposal of the waste WS, and so forth are raised as examples.

Note that the data about the operating situation of the containers TB and the moving bodies 23 and data about a treatment situation of the waste WS at the treatment space 21 are included in the vendor data VND illustrated in FIG. 1. The data about the operating situation and the data about the treatment situation are examples of resource data about resources employed for the waste treatment service and are used for a service simulation (described later).

Activity spaces 31, 32, and 33 are examples of plural homes 3. The activity space 31 is a residence of a user U1, the activity space 32 is a residence of a user U2, and the activity space 33 is a residence of a user U3. The users U1 to U3 are examples of the user UX using the treatment service. To the activity spaces 31, 32, and 33, waste spaces 31a, 32a, and 33a for placing the containers TB are respectively provided. Those waste spaces are provided while facing roads for the moving body 23 at the respective homes, for example. At least one container TB is situated in each of the waste spaces 31a to 33a.

Two or more containers TB corresponding to the kinds of the waste WS may be situated in the waste spaces 31a, 32a, and 33a. The container TB is configured to be identifiable in accordance with the kind of the waste WS. For example, the container TB is colored with an identification color corresponding to the kind of the waste WS. In another example, an identification sign corresponding to the kind of the waste WS is put on an outside surface of the container TB. As identification signs, two-dimensional codes such as a barcode and a QR code(R) and a radio-frequency identification (RFID) tag, and so forth are raised as examples.

To the waste spaces 31a, 32a, and 33a, sensors 31b, 32b, and 33b are respectively provided. Each of the sensors obtains data about a collection situation of the waste WS by the container TB situated in the waste space. As the data about the collection situation, a kind of the waste WS contained in the container TB, a weight of the waste WS contained in the container TB, a collection rate of the waste WS by the container TB, a detention time of the waste WS contained in the container TB, and a concentration of specific gas (odor level) around the container TB are raised as examples. The data obtained by the sensor 31b are transmitted to a terminal 31c of the user U1. The data obtained by the sensor 32b are transmitted to a terminal 32c of the user U2, and the data obtained by the sensor 33b are transmitted to a terminal 33c of the user U3.

The terminals 31c, 32c, and 33c are computers (such as smartphones and tablets, for example) which are respectively carried by the users U1, U2, and U3, for example. The terminals 31c, 32c, and 33c may be computers which are respectively installed in the activity spaces 31, 32, and 33.

As the waste WS produced in the home 3, vessels and packages of products PD are raised as examples. Representative products PD are consumable articles such as daily commodities and office supplies and food, and various kinds of vessels and packages of the products PD are present. For example, when the vessels and packages are categorized based on materials and shapes, glass bottles, aluminum cans, steel cans, PET bottles, paper vessels and packages, and plastic vessels and packages are raised as examples. Liquid consumable articles or food are mainly enclosed in glass bottles, aluminum cans, steel cans, and PET bottles. Solid consumable articles or food are mainly enclosed in vessels and packages which are formed of paper or plastic.

Data about purchase of the product PD by the user UX are recorded in a user terminal 3Xc (which denotes a terminal of the user UX, and the same applies to the following). For example, data about the product PD purchased by using a communication function of the user terminal 3Xc are recorded in the user terminal 3Xc. In another example, an image is obtained from a camera installed in a preservation space (not illustrated) such as a refrigerator or a storeroom provided to the home 3, and the product PD purchased by the user is specified by recognition of an object included in the image. Accordingly, the data about purchase of the product PD by the user UX are recorded in the user terminal 3Xc.

The data about the collection situation of the waste WS by the sensors 31b, 32b, and 33b and the data about purchase of the products PD by the users U1, U2, and U3 are included in the user data USR illustrated in FIG. 1. At least one set of data between the data about the collection situation of the waste WS and the data about purchase of the products PD is used for calculation of a discharging tendency (described later) of the waste WS.

### 1-2. Level of Waste Treatment Service

In the embodiment, a level SL of the waste treatment service (hereinafter, also referred to as “service level”) will be discussed. The service level SL can be estimated based on time elements about the treatment service, resource elements about resources to be consumed in practice of the treatment service, and so forth, for example. As the time elements, punctuality (for example, a delay time from a planned time point to an execution time point of retrieval of and replenishment with the container TB which are regularly performed), immediacy (for example, a waiting time from a demanding time point to an execution time point of retrieval of and replenishment with the container TB), and so forth are raised as example. As the delay time or the waiting time becomes shorter, the service level SL becomes higher. As the resource elements, fuel and electric power for operating the moving bodies 23 and a disposal facility of the waste WS are raised as examples. As a fuel consumption rate or an electric power consumption rate becomes lower, the service level SL becomes higher.

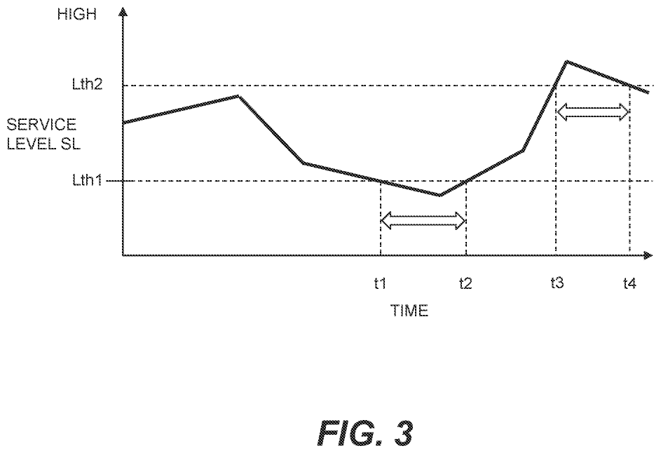

Elements used for estimation of the service level SL are elements related to time. Thus, the service level fluctuates depending on hours (time range). FIG. 3 is a diagram for explaining a transition example of the service level SL. In the example illustrated in FIG. 3, the service level SL in consideration of the above-described elements is calculated, and it is thereby understood that the service level SL fluctuates depending on the hours (time range). Then, for example, a tendency that the service level SL is particularly low in a time range of hours t1 to t2 and a tendency that the service level SL is particularly high in a time range of hours t3 to t4 are perceived.

In order to estimate the service level SL, the management server 1 performs a simulation about the waste treatment service (hereinafter, also referred to as “service simulation”). In the service simulation, based on resources (service resources) employed for the treatment service and a need prediction about the treatment service, a state of the waste treatment service is simulated. As the service resources, the containers TB, the moving bodies 23, and disposal equipment of the waste WS are raised as examples. The need prediction about the waste treatment service is performed based on the discharging tendency of the waste WS which is calculated for each of the users of the treatment service. Details of the need prediction and the discharging tendency will be described later.

### 1-3. Suggestion about Modification of Behavior

In order to maintain an estimated service level SL (hereinafter, also referred to as “service level SLE”) in a desirable range, the management server 1 compares the service level SLE with stipulated levels Lth. As the stipulated levels Lth, two kinds of levels which stipulate a lower limit and an upper limit of the desirable range of the service level SL are raised as examples. Those two kinds of levels are a first level Lth1 and a second level Lth2 (Lth2>Lth1) which are illustrated in FIG. 3, for example.

When it is found that the service level SLE falls below the stipulated level Lth (first level Lth1) as a result of a comparison of the service level SLE with the stipulated level Lth, the management server 1 transmits, to the user terminal 3Xc, a notification (hereinafter, also referred to as suggestion notification SGG) which suggests a modification of behavior of at least one of discharge of the waste WS and purchase of the products PD by the user UX. The user terminal 3Xc to which the suggestion notification SGG is transmitted is the terminal of the user UX who demands retrieval of the container TB containing the waste WS and replenishment with the container TB at a day and time (which denotes a date and a time range, and the same applies to the following) when the service level SLE falls below the stipulated level Lth, for example.

The fact that the service level SLE falls below the stipulated level Lth means that the service resources are insufficient relative to the need prediction about the treatment service. Accordingly, as the suggestion notifications SGG, the following is raised as examples.

(i) Encourage a change of the day and time of retrieval of and replenishment with the container TB on demand (a change to a day and time different from the day and time when the service level SLE falls below the stipulated level Lth).

(ii) Encourage purchase of a substitute product which results in a less discharge amount of the waste WS than the product PD (consumable article or food) which the user UX usually purchases.

(iii) Encourage going out or eating out.

In transmitting the suggestion notification SGG, an incentive to encourage behavior based on the suggestion notification SGG (for example, a discount coupon for a treatment service charge, a discount coupon for a substitute product, or a discount coupon for a service for eating out) may be transmitted to the user terminal 3Xc.

When it is found that the service level SLE exceeds the stipulated level Lth (second level Lth2), the management server 1 also transmits the suggestion notification SGG to the user terminal 3Xc. The user terminal 3Xc to which the suggestion notification SGG is transmitted is the terminal of the user UX who demands retrieval of the container TB containing the waste WS and replenishment with the container TB at a day and time different from the day and time when the service level SLE exceeds the stipulated level Lth, for example. As the suggestion notifications SGG, the following is raised as examples.

(iv) Encourage a change of the day and time of retrieval of and replenishment with the container TB on demand (a change to the day and time when the service level SLE exceeds the stipulated level Lth).

(v) Encourage purchase of a substitute product which results in a more discharge amount of the waste WS than the product PD (consumable article or food) which the user UX usually purchases.

In transmitting the suggestion notification SGG, an incentive to encourage behavior based on the suggestion notification SGG (for example, a discount coupon for the treatment service charge or a discount coupon for a substitute product) may be transmitted to the user terminal 3Xc.

As described above, in the embodiment, the service simulation is performed, and the service level SLE is thereby calculated. In the embodiment, the suggestion notification SGG is transmitted to the user terminal 3Xc in accordance with the result of a comparison between the service level SLE and the stipulated levels Lth. Thus, it becomes possible to in advance prevent convenience of the treatment service from being impaired and to maintain the service level SLE in the desirable range. Consequently, it becomes possible to appropriately practice the waste treatment service. As a result of selection of behavior based on the suggestion notification SGG by the user UX, it also becomes possible to reduce the discharge amount of the waste WS from the above user UX. Consequently, it also becomes possible to contribute to maintenance of a sustainable society.

### 2. SYSTEM CONFIGURATION EXAMPLE

### 2-1. General Configuration Example

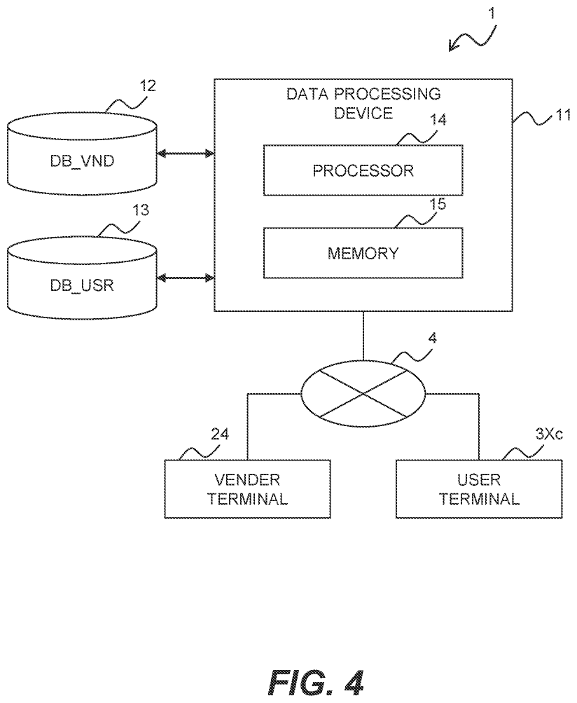

FIG. 4 is a diagram for explaining a general configuration example of a waste treatment system including the management server 1. In the example illustrated in FIG. 4, the waste treatment system includes the vendor terminal 24 and the user terminal 3Xc in addition to the management server 1. The vendor terminal 24 and the user terminal 3Xc communicate with the management server 1 via a communication line network 4. Note that the communication line network 4 is not particularly limited, and wired and wireless networks are used.

The management server 1 includes a data processing device 11 and databases (DB) 12 and 13. The data processing device 11 includes at least one processor 14 and at least one memory 15. The processor 14 includes a central processing unit (CPU). The memory 15 is a volatile memory such as a DDR memory, expands various programs to be used by the processor 14, and temporarily saves various kinds of data. The various programs used by the processor 14 include a waste treatment program according to the embodiment. The various kinds of data used by the processor 14 include data stored in the databases 12 and 13.

The database 12 is formed in a predetermined storage device (for example, a hard disk or a flash memory). The database 12 stores the vendor data VND. The vendor data VND are transmitted from the vendor terminal 24 to the management server 1 via the communication line network 4. As the vendor data VND, identification data about the treatment facility 2 and the vendor managing that, the data about the operating situation of the containers TB and the moving bodies 23, and data about the treatment situation of the waste WS at the treatment space 21 are raised as examples.

Similarly to the database 12, the database 13 is formed in a predetermined storage device. The database 13 stores the user data USR. The user data USR are transmitted from the user terminal 3Xc to the management server 1 via the communication line network 4. As the user data USR, identification data about the homes 3 and the users UX living in those, the data about the collection situation of the waste WS, the collection situation being obtained by the sensors provided to the waste spaces of the homes 3, and the data about purchase of the products PD by the users UX living in the homes 3 are raised as examples.

### 2-2. Function Configuration Example of Management Server

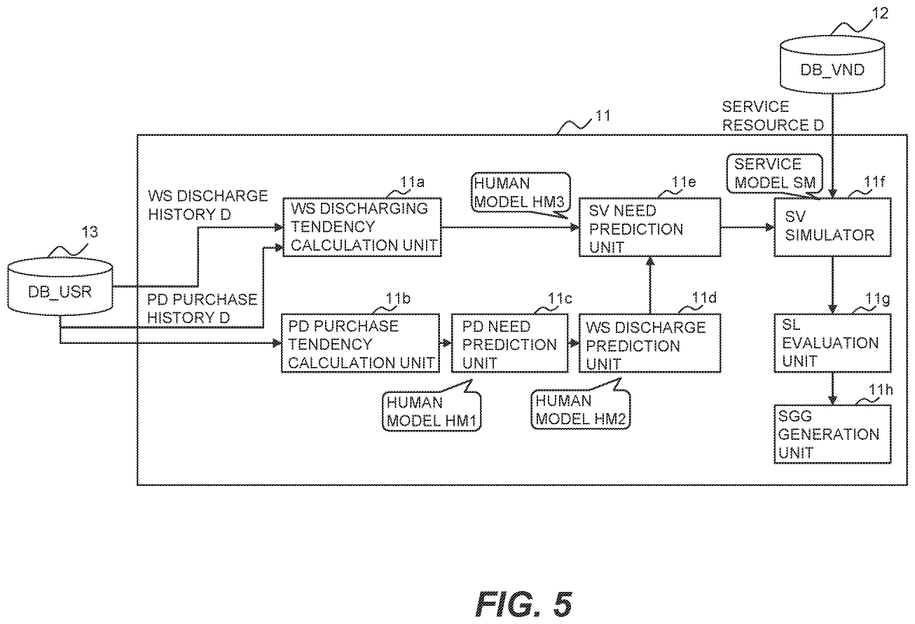

FIG. 5 is a diagram for explaining a function configuration example of the management server 1. In the example illustrated in FIG. 5, the management server 1 includes a WS discharging tendency calculation unit 11a, a PD purchase tendency calculation unit 11b, a PD need prediction unit 11c, a WS discharge prediction unit 11d, an SV need prediction unit 11e, an SV simulator 11f, an SL evaluation unit 11g, and an SGG generation unit 11h. Note that function blocks illustrated in FIG. 5 are realized by execution of the waste treatment program in the memory 15, which is illustrated in FIG. 4, by the processor 14.

The WS discharging tendency calculation unit 11a calculates the discharging tendency of the waste WS for each of the users and transmits that to the SV need prediction unit 11e. As the discharging tendencies of the waste WS, a cycle in which the user UX wastes a consumable article (or food), a time from when a consumable article (or food) is brought into an activity space 3X (which denotes the activity space of the user UX, and the same applies to the following) to when the consumable article (or food) is wasted, a ratio of a weight (or volume) of a wasted consumable article (or food) to the weight (or volume) of the unused consumable article (or food), and so forth are raised as examples. As another example of the discharging tendency of the waste WS, a wasting manner of a consumable article (or food) of the user UX is raised. As wasting manners, for example, throwing away the vessel and package of a certain consumable article (or food) as they are, throwing away several vessels and packages of the same kind of consumable articles (or food) together, and so forth are raised.

The discharging tendency of the waste WS of the user UX is calculated by machine learning based on discharge history data (discharge history D) about the waste WS, for example. The discharge history data are generated from the data about the collection situation of the waste WS, the collection situation being obtained by a sensor 3Xb provided to a waste spaces 3Xa. By using the discharge history data about the waste WS, the cycle in which the user UX wastes a consumable article (or food) can be calculated.

In another example, the discharging tendency of the waste WS of the user UX is calculated based on the discharge history data about the waste WS and data about a time point at which the product PD is brought into the activity space 3X. This bringing time point can be estimated based on an image from a camera which is separately installed in the activity space 3X, for example. The bringing time point is estimated, and the time from when a consumable article (or food) is brought into the activity space 3X to when that is wasted can thereby be calculated.

In another example, the discharging tendency of the waste WS of the user UX is calculated based on a combination of the discharge history data about the waste WS and purchase history data (purchase history D) about the product PD. The purchase history data about the product PD are generated from the data about purchase of the product PD by the user UX. By using the purchase history data about the product PD, information about what kind of consumable article (or food) the waste WS is derived from or information about the weight (or volume) of an unused consumable article (or food) can be obtained. Thus, the ratio of the weight (or volume) of the wasted consumable article (or food) to the weight (or volume) of the unused consumable article (or food) can be calculated.

The PD purchase tendency calculation unit 11b calculates a purchase tendency of the product PD for each of the users and transmits that to the PD need prediction unit 11c. As purchase tendencies of the product PD, a day of the week and a time range in which the user UX purchases a certain consumable article (or food), a cycle of purchase of the above consumable article (or food), a weight (or volume) of the above consumable article (or food) for one purchase, and so forth are raised as examples. As another example of the purchase tendency of the product PD, a purchasing manner of a consumable article (or food) of the user UX is raised. As purchasing manners, for example, purchase by using the communication function of the user terminal, purchase of a consumable article (or food) at a store, and so forth are raised as examples.

The purchase tendency of the product PD of the user UX is calculated by machine learning based on the purchase history data about the product PD, for example. The purchase history data are generated from the data about the product PD purchased by using the communication function of the user terminal 3Xc, for example. In another example, the purchase history data are generated by a recognition process by using an image by a camera which captures an image of the preservation space such as the refrigerator or the storeroom provided to the home 3 of the user UX.

Based on the purchase tendency of the product PD which is received from the PD purchase tendency calculation unit 11b, the PD need prediction unit 11c predicts a need for the product PD for each of the users and transmits that to the WS discharge prediction unit 11d. A need prediction about the product PD is performed by applying data indicating the purchase tendency of the product PD to a human model (prediction model) MH1, which uses, as a parameter, the data indicating the purchase tendency of the product PD, for example. The human model MH1 models behavior of purchasing the product PD by the user UX. The human model MH1 is prepared for each of the users. The human model MH1 may be prepared for each group of users having the same attributes (for example, age or sex) as attributes of the user UX.

Based on the need prediction about the product PD, which is received from the PD need prediction unit 11c, the WS discharge prediction unit 11d predicts a discharge of the waste WS for each of the users and transmits that to the SV need prediction unit 11e. A discharge prediction about the waste WS is performed by applying data indicating the need prediction about the product PD to a human model (prediction model) MH2, which uses, as a parameter, the data indicating the need prediction about the product PD, for example. The human model MH2 models behavior of discharging the waste WS from the product PD by the user UX. The human model MH2 is prepared for each of the users. Similarly to the human model MH1, the human model MH2 may be prepared for each group of users having the same attributes as the attributes of the user UX.

Based on at least one of the discharging tendency of the waste WS which is received from the WS discharging tendency calculation unit 11a and the discharge prediction about the waste WS which is received from the WS discharge prediction unit 11d, the SV need prediction unit 11e predicts a need for a treatment service (SV) for each of the users. As needs for the treatment service (SV), a need for regular retrieval of and replenishment with the container TB and a need for retrieval of and replenishment with the container TB on demand are raised as examples. The SV need prediction unit 11e may individually predict the need for regular retrieval and replenishment and the need for retrieval and replenishment on demand.

The need prediction about the treatment service is performed by applying at least one set of data between data indicating the discharging tendency of the waste WS and data indicating the discharge prediction about the waste WS to a human model (prediction model) MH3, which uses, as a parameter, at least one set of data between the data indicating the discharging tendency of the waste WS and the data indicating the discharge prediction about the waste WS, for example. The human model MH3 models behavior of using the treatment service by the user UX. The human model MH3 is prepared for each of the users. The human model MH3 may be prepared for each group of users having the same attributes as the attributes of the user UX.

The SV simulator 11f performs the service simulation. In the service simulation, for example, service resource data (service resource D) and data indicating the need prediction about the treatment service by the SV need prediction unit 11e are applied to a service model (prediction model) SM, which uses, as parameters, the service resource data and the data indicating the need prediction about the treatment service, and the state of the treatment service is thereby simulated. As the service resource data, the data about the operating situation of the containers TB and the moving bodies 23 and the data about the treatment situation of the waste WS at the treatment space 21 are raised as examples. The SV simulator 11f estimates the service level SL by the above service simulation and transmits the service level SLE to the SL evaluation unit 11g.

The SL evaluation unit 11g compares the service level SLE received from the SV simulator 11f with the stipulated levels Lth. As the stipulated levels Lth, the first level Lth1 and the second level Lth2 which are illustrated in FIG. 3 are raised as examples. When a day and time when the service level SLE falls below the first level Lth1 is present, for example, the SL evaluation unit 11g transmits information about the day and time to the SGG generation unit 11h. In another example, when a day and time when the service level SLE exceeds the second level Lth2 is present, the SL evaluation unit 11g transmits information about the day and time to the SGG generation unit 11h.

When the information about the day and time is received from the SL evaluation unit 11g, the SGG generation unit 11h generates the suggestion notification SGG. In generation of the suggestion notification SGG, the user UX as a target of the suggestion notification SGG is specified. The above user UX is the user who demands retrieval of the container TB containing the waste WS and replenishment with the container TB at the day and time when the service level SLE falls below the first level Lth1, for example. In another example, the above user UX is the user who demands retrieval of the container TB containing the waste WS and replenishment with the container TB at a day and time different from the day and time when the service level SLE exceeds the second level Lth2.

When the user UX as the target of the suggestion notification SGG is specified, the SGG generation unit 11h generates the suggestion notification SGG to be transmitted to the user UX. For the user UX who demands retrieval of the container TB containing the waste WS and replenishment with the container TB at the day and time when the service level SLE falls below the first level Lth1, information of the above (i) to (iii) is generated by referring to the data about the collection situation of the waste WS and the data about purchase of the product by the user UX. By a similar procedure to this, for the user UX who demands retrieval of the container TB containing the waste WS and replenishment with the container TB at a day and time different from the day and time when the service level SLE exceeds the second level Lth2, information of the above (iv) and (v) is generated.

### 2-3. Data Processing Example

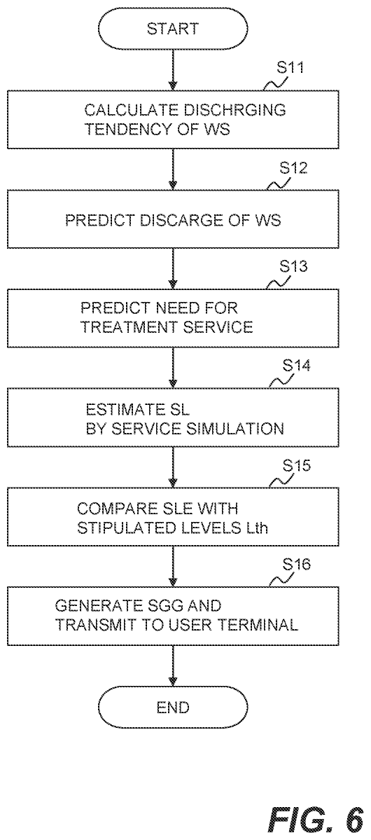

FIG. 6 is a flowchart illustrating a flow of processing executed by the data processing device 11 (processor 14) and particularly relates to the embodiment. Note that a routine illustrated in FIG. 6 is repeatedly executed in a constant cycle.

In the routine illustrated in FIG. 6, the discharging tendency of the waste WS is first calculated (step S11). In the processing in step S11, the discharging tendency of the waste WS is calculated for each of the users. The discharging tendency of the waste WS of the user UX is calculated by machine learning based on the discharge history data about the waste WS, for example. The discharge history data are generated from the data about the collection situation of the waste WS, the collection situation being obtained by the sensor 3Xb provided to the waste space 3Xa.

In another example, the discharging tendency of the waste WS of the user UX is calculated based on the discharge history data about the waste WS and the data about the time point at which the product PD is brought into the activity space 3X. In another example, the discharging tendency of the waste WS of the user UX is calculated based on the combination of the discharge history data about the waste WS and the purchase history data about the product PD.

Following the process in step S11, the discharge of the waste WS is predicted (step S12). In the processing in step S12, the discharge prediction about the waste WS is performed for each of the users. The discharge prediction about the waste WS is performed by applying the data indicating the need prediction about the need for the product PD by the user UX to the human model MH2 described by using FIG. 5, for example. The need prediction about the need for the product PD by the user UX is performed by applying the data indicating the purchase tendency of the product PD of the user UX to the human model MH1 described by using FIG. 5. The purchase tendency of the product PD of the user UX is calculated based on the purchase history data about the product PD.

Following the process in step S12, the need for the treatment service is predicted (step S13). In the processing in step S13, for example, at least one set of data between the data indicating the discharging tendency of the waste WS and the data indicating the discharge prediction about the waste WS is applied to the human model MH3 described by using FIG. 5, and the need for the treatment service is thereby predicted.

Following the process in step S13, the service level SL is estimated by the service simulation (step S14). In the processing in step S14, for example, the service resource data and the data indicating the need prediction obtained by the process in step S13 are applied to the service model SM, and the service level SL is thereby simulated.

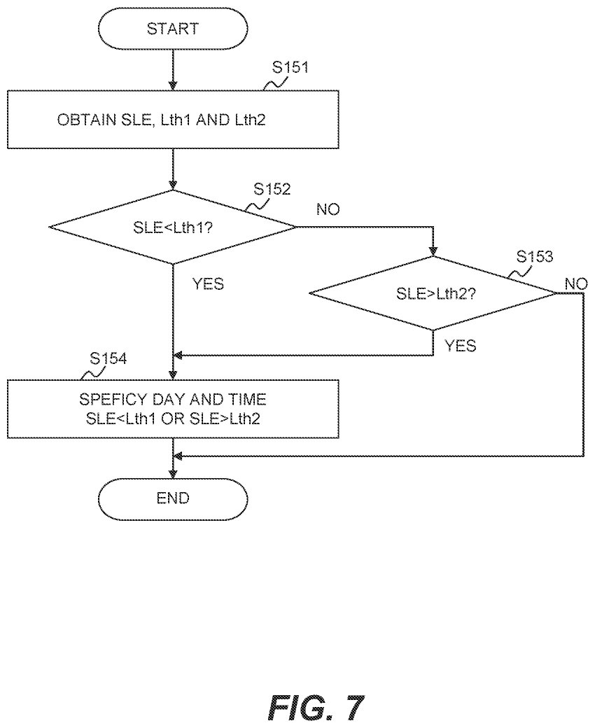

Following the process in step S14, the service level SL (in other words, the service level SLE) estimated in the process in step S14 is compared with the stipulated levels Lth (step S15). Details of the processing in step S15 will be described with reference to FIG. 7. FIG. 7 is a flowchart illustrating a flow of the processing executed in step S15.

In a routine illustrated in FIG. 7, first, the service level SL (service level SLE) estimated in the process in step S14, the first level Lth1, and the second level Lth2 are obtained (step S151). Next, the service level SLE is compared with the first level Lth1 and the second level Lth2 (steps S152 and S153).

When the service level SLE falls below the first level Lth1 or a case where the service level SLE exceeds the second level Lth2, the processing in step S154 is performed. In the process in step S154, the day and time when the service level SLE falls below the first level Lth1 is specified. Alternatively, the day and time when the service level SLE exceeds the second level Lth2 is specified.

Returning to FIG. 6, the description about the flow of the process will be continued. Following the process in step S15, the suggestion notification SGG is generated and transmitted to the user terminal UXc. The user UX as the target of the suggestion notification SGG is the user who demands retrieval of the container TB containing the waste WS and replenishment with the container TB at the day and time when the service level SLE falls below the first level Lth1, for example. In another example, the above user UX is the user who demands retrieval of the container TB containing the waste WS and replenishment with the container TB at a day and time different from the day and time when the service level SLE exceeds the second level Lth2. Note that the day and time when the service level SLE falls below the first level Lth1 and the day and time when the service level SLE exceeds the second level Lth2 are specified by the process in step S154.

### 3. EFFECTS

In the embodiment described in the foregoing, the suggestion notification SGG is transmitted to the user terminal 3Xc in accordance with the result of the comparison between the service level SLE and the stipulated levels Lth. Thus, it becomes possible to in advance prevent convenience of the treatment service from being impaired and to maintain the service level SLE in the desirable range. Consequently, it becomes possible to appropriately practice the waste treatment service. As a result of selection of behavior based on the suggestion notification SGG by the user UX, it also becomes possible to reduce the discharge amount of the waste WS from the above user UX. Consequently, it also becomes possible to contribute to maintenance of a sustainable society.

What is claimed is:

1. A method of managing a service related to waste treatment, the method comprising the steps of:
obtaining at least one of a discharge history of discharge of waste by a user using the service and a purchase history of a product by the user;
calculating at least one of a discharging tendency of discharge of the waste by the user based on the discharge history and a discharge prediction about discharge of the waste by the user based on the purchase history;
calculating a need prediction about the service by using a prediction model which uses, as a parameter, at least one of the discharging tendency of the waste and the discharge prediction about the waste;
estimating a level of the service by a simulation which uses, as parameters, the need prediction and a resource employed for the service; and
transmitting, to a terminal of the user, a notification which suggests a modification of behavior of at least one of discharge of the waste and purchase of a product by the user based on a comparison result between an estimated level and a stipulated level of the service.

2. The method according to claim 1,
wherein, when the comparison result is obtained which indicates that the estimated level falls below the stipulated level, the notification which suggests the modification includes information about a service charge corresponding to a day and time when the waste is collected and information which encourages reduction in production or discharge of the waste.

3. The method according to claim 1,
wherein, when the comparison result is obtained which indicates that the estimated level exceeds the stipulated level, the notification which suggests the modification includes information about a service charge corresponding to a day and time when the waste is collected and information which encourages an increase in production or discharge of the waste.

4. A device of managing a service related to waste treatment, the device comprising:
a memory which stores at least one of a discharge history of discharge of waste by a user using the service and a purchase history of a product by the user; and
a processor configured to execute processing based on data stored in the memory,
wherein, the processor is configured to:
calculate at least one of a discharging tendency of discharge of the waste by the user based on the discharge history of the waste and a discharge prediction about discharge of the waste by the user based on the purchase history;
calculate a need prediction about the service by using a prediction model which uses, as a parameter, at least one of the discharging tendency of the waste and the discharge prediction about the waste;
estimate a level of the service by a simulation which uses, as parameters, the need prediction and a resource employed for the service; and
transmit, to a terminal of the user, a notification which suggests a modification of behavior of at least one of discharge of the waste and purchase of a product by the user based on a comparison result between an estimated level and a stipulated level of the service.

5. A non-transitory computer-readable medium storing a program for managing a service related to waste treatment, the program causing a computer to execute:
processing to obtain at least one of a discharge history of discharge of waste by a user using the service and a purchase history of a product by the user;
processing to calculate at least one of a discharging tendency of discharge of the waste by the user based on the discharge history and a discharge prediction about discharge of the waste by the user based on the purchase history;
processing to calculate a need prediction about the service by using a prediction model which uses, as a parameter, at least one of the discharging tendency of the waste and the discharge prediction about the waste;
processing to estimate a level of the service by a simulation which uses, as parameters, the need prediction and a resource employed for the service; and
processing to transmit to a terminal of the user a notification which suggests a modification of behavior of at least one of discharge of the waste and purchase of a product by the user based on a comparison result between an estimated level and a stipulated level of the service.
